(19) United States
(12) Patent Application Publication
(10) Pub. No.: US 2013/0099910 A1
(43) Pub. Date: Apr. 25, 2013

(54) SYSTEM AND METHOD FOR ALERTING OBSTRUCTION FOR CARGO MOUNTED ON A VEHICLE

(71) Applicant: JANNEH MERRITT, Brisbane, CA (US)

(72) Inventor: JANNEH MERRITT, Brisbane, CA (US)

(21) Appl. No.: 13/315,187

(22) Filed: Dec. 8, 2011

Related U.S. Application Data
(63) Continuation-in-part of application No. 13/277,453, filed on Oct. 20, 2011.

(51) Int. Cl. B60Q 1/00

(52) U.S. Cl. 340/435; 340/438

(57) ABSTRACT

Systems and methods may be provided for alerting a user of an obstruction to cargo mounted on a vehicle. A non-Doppler non-Radar obstruction sensing device may be provided that may be mounted on the cargo. The non-Doppler non-Radar obstruction sensing device may include an engagement mechanism configured to attach the obstruction sensing device to the cargo, a laser emitter configured to emit a detection signal and a transmitter configured to transmit an alarm signal.

### CLAIM OF PRIORITY

This application is a continuation-in-part of and incorporates by reference in its entirety U.S. patent application Ser. No. 13/277,453 titled “System and Method For Alerting Obstruction For A Bicycle Mounted On A Vehicle” and filed on Oct. 20, 2011.

### BACKGROUND

Cargo, such as overhead cargo, skis, snowboards, bicycles, etc. may be carried on the roof of a vehicle. A risk associated with this practice is forgetting that the cargo is on the vehicle when driving the vehicle. It is well known that people attempt to enter their garage, a tunnel, or other structure with the object still on the roof of the vehicle. When this happens, damage can occur to the object, the roof rack, the vehicle, and the garage. Similarly, damage may occur when a vehicle with a roof-mounted object drives beneath any low-ceilinged passage or low-overhanging structure.

There are some existing solutions to this problem. One is to place a garbage can or other object in the entrance of the garage so that when returning, the vehicle cannot enter the garage. The object serves as a reminder to the driver. Another method is to place a mirror above the garage door so that when attempting to enter the garage, the bicycle can be seen, reminding the driver to remove it. Another method is to put the vehicle's garage door opener in an inconvenient place. When retrieving the opener, the driver is more likely to remember that the bicycle is on the vehicle. Another option is to discontinue parking the car in the garage. Finally, there are numerous collision avoidance systems for vehicles based on video signals or interpreting the reflections from laser or ultrasonic sources. These are used to find and identify hazards in the vehicle's path.

There are shortcomings to all these solutions. The garbage can method requires the driver to place and remove the garbage can or other object. Additionally, it is possible for the driver to forget to place the object or for someone other than the driver to move the object. The mirror method requires a large mirror so that it is not overlooked when entering the garage. A large minor mounted above the garage is not aesthetically pleasing. Putting the garage door opener in a hard to access place is an inconvenience and a step that can be forgotten. The option of not using the garage has the obvious shortcoming that the driver no longer enjoys the benefits of parking their car in a garage. The collision avoidance systems have the shortcoming that they do not have the ability to detect when there is a difference in the vehicle, such as the presence or absence of a snowboard on top. Without this capability, the collision avoidance system will give many false positives. This could result in the user ignoring a genuine positive and cause a collision.

Another attempt to solve this problem is to provide a detector within a roof rack of a vehicle that emits a signal when cargo is mounted on the roof rack. See U.S. Patent Publication No. 2009/0256707, which is hereby incorporated by reference in its entirety. However, this may require that the cargo be precisely placed on the roof track in order to engage the detector. Also, this does not accommodate for different heights in the vehicle or the cargo, which may result in false positives, or not detecting a genuine collision threat.

Therefore, a need exists for improved systems and method for alerting a user of an obstruction for an object mounted on a vehicle. A further need exists to alert a user of an obstruction for cargo mounted in a roof of a vehicle.

### SUMMARY

This invention relates to protecting cargo that is mounted atop a vehicle's roof. Many vehicles have roof racks that can accommodate cargo. An obstruction sensing device that is fixed on cargo will prevent car owners from damaging cargo fixed atop of vehicles. Individuals that have ruined cargo and garages can now be warned of impending or low hanging structures that could potentially damage the cargo, car and potentially garages and other low fixtures. With this invention, cargo owners can now be warned prior to coming into contact with low hanging fixtures. Obstruction sensing devices can be mounted separately on individual pieces of cargo.

The existing alternatives to using a cargo-mounted obstruction sensing device are plenty. By placing the cargo behind the vehicle, instead of mounting the cargo on top the vehicle, an individual can travel without using the device. An obstruction sensing device may still be desirable if the vehicle does not have a backup camera, by using the seat post device as a rear sensor. The individual(s) could also place the cargo in the vehicle and not utilize the benefits of the devices. Another existing solution is to leave a marker in the car to remind the driver that cargo is atop the car. Another option is to stop parking in the garage or under low hanging fixtures and park out side on the street or in the driveway.

The advantages to using this device would allow the individual to not worry about the safety of their expensive cargo on top of the car, or mounted at the rear of the car. Damaging public and private property would no longer be an issue. The driver would not have to second-guess whether the vehicle will fit underneath a low hanging fixture. The driver does not have to get out of the car to decide whether or not the car and cargo can fit under the structure. The advantages of this device are that the technology is simple and reliable. The device may incorporate technology has been around for over 50 years and may incorporate commonly used components that may be used regularly in many devices such as remotes and motion/proximity sensors.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides an overhead view of an obstruction sensing device in accordance with an embodiment of the invention.

FIG. 2 provides a vehicle view of a vehicle with cargo on top, according to one embodiment of the invention.

FIG. 3 provides a display view of the display system for non-Doppler non-Radar detecting of an obstruction and three different modes of operation, according to one embodiment.

FIG. 4 is an overhead view of the non-Doppler non-Radar obstruction sensing device attached to the front and rear of a vehicle, according to one or more embodiments.

FIG. 5 illustrates an initialization view showing the connection between the non-Doppler non-Radar obstruction sensing devices and the in-vehicle display system, according to one or more exemplary embodiments.

FIG. 6 is a flow chart illustrating one embodiment of the invention.

FIG. 7 is a diagrammatic view of a data processing system in which any of the embodiments disclosed herein may be performed, according to one embodiment.

### DETAILED DISCLOSURE OF THE EMBODIMENTS

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and method for alerting a user of an obstruction for cargo 210 mounted on a vehicle 202. Various aspects of the invention described herein may be applied to any of the particular applications set forth below or for any other types of obstruction sensing systems and methods. The invention may be applied as a standalone system or method, or as part of a cargo 210 monitoring and protection system. It shall be understood that different aspects of the invention can be appreciated individually, collectively, or in combination with each other.

According to an embodiment, a non-Doppler non-Radar obstruction sensing device 204 may be used to prevent cargo 210 from being damaged while on top of vehicle 202. The non-Doppler non-Radar obstruction sensing device 204 may prevent the cargo 210 from being damaged while mounted on the rear of vehicle 202, or protruding from any side or portion of vehicle 202. The non-Doppler non-Radar obstruction sensing device 204 may send an alarm signal 208 in a first direction. If an obstruction is encountered, the alarm signal 208 may be bounced back from the obstruction. Upon receiving that same bounced alarm signal 208, the non-Doppler non-Radar obstruction sensing device 204 would trigger an alarm signal 208. This alarm signal 208 would signal the driver that an obstruction, such as a low hanging structure, is present or approaching, according to one or more exemplary embodiments.

Examples of obstructions may include a garage, sign, bridges, tunnels, underpasses, overpasses, low-hanging structures, or low-hanging branches. The alarm signal 208 may warn a driver o the obstruction in sufficient time so that the driver can prevent vehicle 202 from crashing into the obstruction with the cargo 210 mounted on the vehicle. This may prevent costly damage to cargo 210 and/or vehicle 202.

The alarm signal 208 may be an infrared (IR) signal, according to one embodiment. Other examples of alarm signals may include but are not limited to radio signal (such as radiofrequency RF signal), ultrasonic signal, laser, LED, or other visible optical signal. The alarm signal 208 may be based on non-Doppler and non-Radar technologies, according to one or more exemplary embodiments.

Cargo 210 may be referred to as an obstruction or proximity sensor target, according to one example. Different proximity sensor targets may or may not require different sensors. Preferably, a sensing mechanism for the non-Doppler non-Radar obstruction sensing device 204 may be selected to be agnostic to the material of cargo 210. Types of sensors that may incorporated with the non-Doppler non-Radar obstruction sensing device 204 may include inductive sensors, capacitive sensors, capacitive displacement sensors, eddy-current sensors, magnetic sensors, photocell (reflective) sensors, laser rangefinder, sonar (typically active or passive), radar, passive thermal infrared, passive optical (such as charge-coupled devices), or reflection of ionizing radiation. According to one embodiment, the laser sensor itself may be based exclusively on non-Doppler and non-Radar based technologies.

According to one embodiment, the maximum distance that this laser sensor can detect is defined “nominal range”. Some sensors may have adjustments of the nominal range or means to report a graduated detection distance. In some embodiments, the nominal range may be a set parameter. For example, a user may be able to select a non-Doppler non-Radar obstruction sensing device 204 that may have a particular nominal range. In other embodiments, the non-Doppler non-Radar obstruction sensing device 204 may have a user adjustable nominal range. For example, the user may set the obstruction sensing device to provide an alarm signal 208 if an obstruction falls within a particular range of distance set by the user. For example, the nominal range may be about 3 feet or less, 5 feet or less, 7 feet or less, 8 feet or less, 9 feet or less, 10 feet or less, 12 feet or less, 15 feet or less, 17 feet or less, 20 feet or less, 25 feet or less, 30 feet or less, 35 feet or less, 40 feet or less, 50 feet or less, 60 feet or less, 70 feet or less, 80 feet or less, 90 feet or less, 100 feet or less, 120 feet or less, 150 feet or less, 200 feet or less, or any other numerical value or less from the non-Doppler non-Radar obstruction sensing device 204, according to one or more embodiments.

In other embodiments, the non-Doppler non-Radar obstruction sensing device 204 may be able to determine the approximate distance of the obstruction and may provide different types of alerts or alarm signals depending on how far away the obstruction is. For example, a first type of alarm signal 208A may be provided when an obstruction is sensed at a greater distance, and a second type of alarm signal 208B may be provided when an obstruction is sensed at a closer distance. For example, an alarm signal of a first volume, pitch, rhythm, or other sound quality may be provided when the obstruction is within a first range of distance away, and an alarm signal of a second volume, pitch, rhythm, or other sound quality may be provided when the obstruction is within a second range of distance away. In one example, a soft alarm signal may be provided when an obstruction is 30-50 feet away, and a louder alarm signal may be provided when the obstruction is 0-30 feet away.

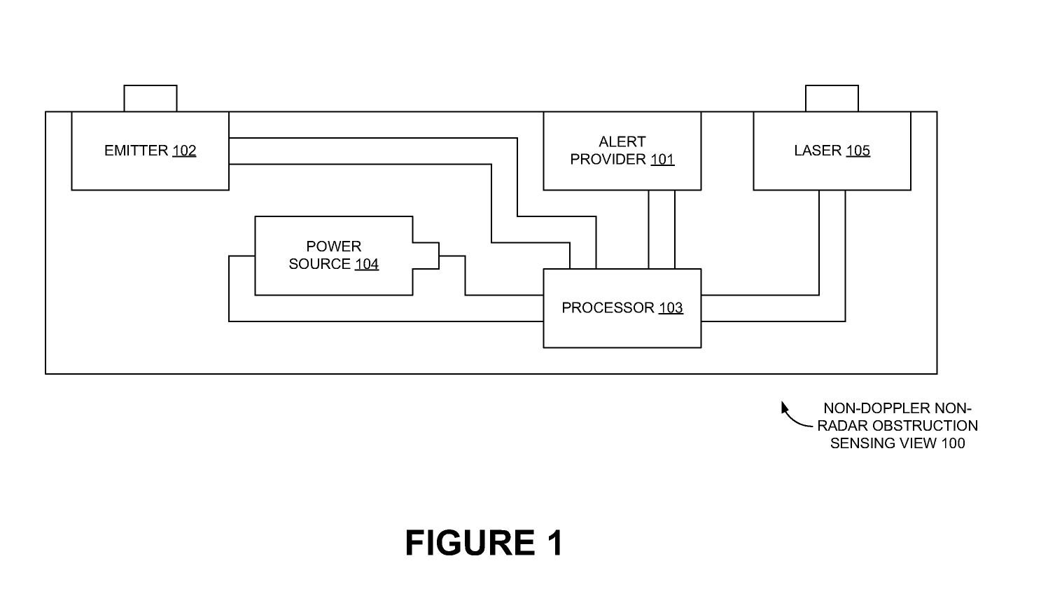

FIG. 1 provides an overhead view of the non-Doppler non-Radar obstruction sensing device 204 in accordance with an embodiment of the invention. The non-Doppler non-Radar obstruction sensing device 204 may have an emitter 102 (e.g., a laser) that may send a laser beam. If laser 105 detects an obstruction it may trigger an alarm signal 208. The emitter 102, laser 105 and display system 302 may be in communication with a processor 103. A power source 104 may be connected to the processor and/or emitter and processor, according to one or more embodiments.

The emitter 102 may send a laser beam. The laser beam may be any type of signal, including those previously discussed. The beam may be an infrared signal. The emitter may be an infrared beacon. The laser beam may be emitted continuously or periodically. For example, the laser beam may be emitted about every 0.1 seconds, 0.25 seconds, 0.5 seconds, 1 seconds, 1.5 seconds, 2 seconds, 3 seconds, 4 seconds, 5 seconds, 7 seconds, 10 seconds, 15 seconds, 20 seconds, or 30 seconds. The beam may be emitted in a particular direction. For example, a laser beam may be emitted towards a “front” side of the non-Doppler non-Radar obstruction sensing device 204. The laser beam may be a narrow focused laser beam, or may cover a wide area in the direction. In some embodiments, the laser beam may be emitted to cover a roughly conical space with the emitter at the apex. The conical shape may have any angle at the apex. For example, the angle may be about 0.1 degrees or less, 0.25 degrees or less, 0.5 degrees or less, 0.75 degrees or less, 1 degree or less, 1.5 degree or less, 2 degrees or less, 3 degrees or less, 4 degrees or less, 5 degrees or less, 6 degrees or less 7 degrees or less, 8 degrees or less, 9 degrees or less, 10 degrees or less, 12 degrees or less, 15 degrees or less, 20 degrees or less. The laser beam emitted may cover a sufficient area to detect an obstruction that may come in contact with cargo 210 while reducing the likelihood of false positives, according to one or more embodiments.

A laser 105 may need to be broken to trigger alarm signal 208, according to one or more embodiments. When an emitted laser beam encounters an obstruction, it may reflect back to the non-Doppler non-Radar obstruction sensing device 204. In some embodiments, the laser 105 may be separate from the emitter 102. Alternatively, they may be integrated. In some embodiments, the strength of the emitter and/or the sensitivity of the emitter may adjusted to vary the nominal range. In some embodiments, the nominal range may be determined at the factory during manufacture. In some other embodiments, the nominal range may be automatically adjusted or may be adjusted by the user. A user may select a desired nominal range, according to one or more embodiments.

The alarm signal 208 may be the same or different signal from the emitted signal. The alarm signal 208 may be any wireless signal. In some embodiments, the alarm signal 208 may be an RF signal. In some embodiments, the alarm signal 208 may be emitted in one direction, many directions, or all directions. The alarm signal 208 may be received by an alarm emitting device.

In some embodiments, the processor may include tangible/non-transitory computer readable media including computer code, instructions, or logic, for completing one or more steps or algorithm. A memory may be provided to the obstruction sensing device and may store one or more set of instructions or algorithm.

A system power source 104 may be connected to the processor and/or emitter and processor. In some embodiments, the power source may be a local energy storage device, such as a battery or ultra capacitor. In some embodiments, the energy storage system may include, but is not limited to, lead-acid (“flooded” and VRLA) batteries, NiCad batteries, nickel metal hydride batteries, lithium ion batteries, Li-ion polymer batteries, zinc-air batteries or molten salt batteries. In some embodiments, the local energy storage may preferably have a battery life exceeding 2 hours, 4 hours, 6 hours, 8 hours, 10 hours, 12 hours, 15 hours, 20 hours, 25 hours, or 30 hours. In some embodiments, the local energy storage may be rechargeable. In other embodiments, the power source may be connected to an external power source, such as the vehicle, or external energy storage system. In some embodiments, the power source may include an energy converting or generating device. For example, the power source may use solar energy and/or wind energy to recharge the energy storage system or to provide energy to the processor and other components.

The non-Doppler non-Radar obstruction sensing device 204 may be provided in accordance with an embodiment of the invention. The non-Doppler non-Radar obstruction sensing device 204 device may include an engagement mechanism configured to attach the non-Doppler non-Radar obstruction sensing device 204 to cargo 210. In some embodiments, the engagement mechanism may be configured to attach the non-Doppler non-Radar obstruction sensing device 204 to rails above a vehicle. In some other embodiments, the engagement mechanism may be configured to attach the non-Doppler non-Radar obstruction sensing device 204 a portion of cargo 210. The engagement mechanism may keep the non-Doppler non-Radar obstruction sensing device 204 stationary relative to the cargo 210 while the vehicle 202 is in motion. The engagement mechanism may or may not be adjustable to accommodate different shapes or sizes of cargo. The engagement mechanism may optionally be shaped to fit a specific part of the cargo being carried.

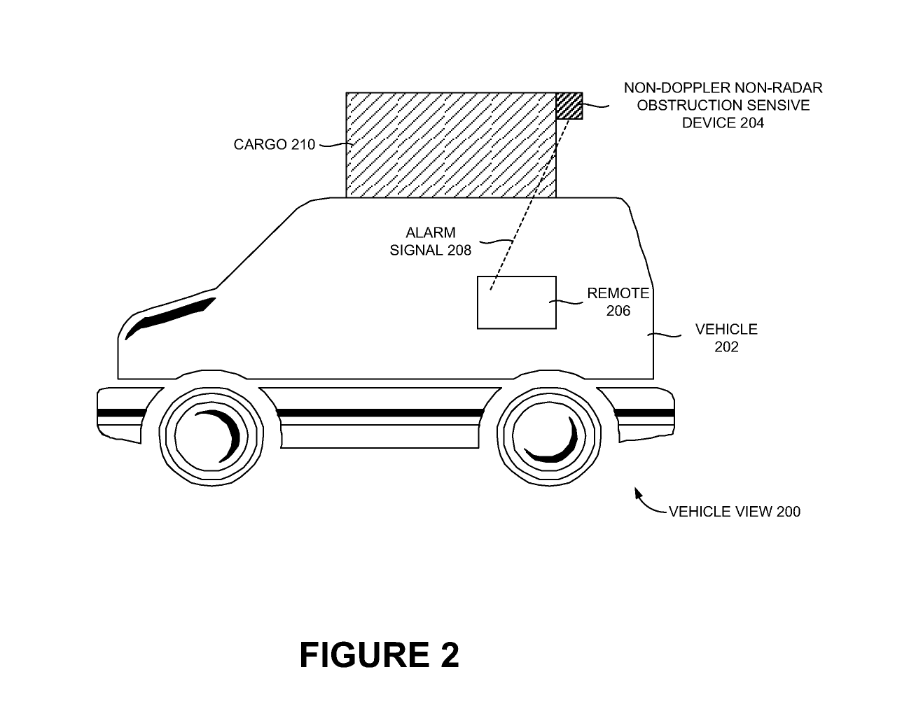

FIG. 2 provides an example of a rail-mounted obstruction sensing device. A rail-mounted obstruction sensing device may project a signal, such as an infrared signal, from the device located on the bike seat rail bars to detect objects that are nearby or approaching objects within range. Upon receiving a bounced return signal, the device could trigger an alarm. It may sends signal to detect objects that are within a set nominal range. This alarm could signal the driver that a low hanging structure is present or approaching, or that any obstruction within a particular direction of the device is approaching.

FIG. 2 illustrates a vehicle view 200 provided in accordance with an embodiment of the invention. The alert system may include cargo 210, which may be mounted on a vehicle 202. The non-Doppler non-Radar obstruction sensing device 204 may be mounted on cargo 210. A remote 206 may be provided to a user or may be within the vehicle. In some embodiments, the remote may be part of the vehicle. One or more alarm signal 208 may be provided by the non-Doppler non-Radar obstruction sensing device 204, and may be received by the remote, according to one or more exemplary embodiments.

The cargo 210 may be mounted to the roof of the vehicle 202. In alternate embodiments, the cargo may be mounted at the rear the vehicle, or within a trunk or bed of the vehicle. The non-Doppler non-Radar obstruction sensing device 204 may be mounted on the cargo 210. In some embodiments, the non-Doppler non-Radar obstruction sensing device 204 may be mounted beneath cargo 210. In other embodiments, the non-Doppler non-Radar obstruction sensing device 204 may be mounted to a front of cargo 210, rear of cargo 210 or anywhere on cargo 210.

The non-Doppler non-Radar obstruction sensing device 204 may be facing forward relative to the vehicle 202. Alternatively, it may be facing toward the rear of vehicle 202, a side of vehicle 202, or angled relative to vehicle 202. The non-Doppler non-Radar obstruction sensing device 204 may be angled up or down to sense an obstruction at a relevant height relative to vehicle 202. For example if the cargo 210 is mounted to the roof of the vehicle, the non-Doppler non-Radar obstruction sensing device 204 may be angled to detect an obstruction that may be sufficiently low hanging to hit cargo 210 and to provide a sufficient amount of warning so that an operator of vehicle 202 may have time to hit the brakes. The non-Doppler non-Radar obstruction sensing device 204 may also be angled or have a sufficient sensitivity to detect such an obstruction without generating many false positives, according to one or more embodiments.

In some embodiments, the non-Doppler non-Radar obstruction sensing device 204 may be able to sense obstructions in multiple directions. For example, one or more the non-Doppler non-Radar obstruction sensing devices (e.g., 204A or 204B) may be used to sense an obstruction to the front of cargo 210, to the rear of cargo 210 and/or to the side of cargo 210. In some embodiments, a single non-Doppler non-Radar obstruction sensing device 204 may be able to sense obstructions in multiple directions. In some embodiments, a plurality of emitters and/or receivers may be provided, which may detect obstructions in multiple directions. For example, the non-Doppler non-Radar obstruction sensing device 204 may have a laser emitter to the front of the device, and a laser emitter to the rear of the device. In other embodiments, the non-Doppler non-Radar obstruction sensing device 204 may only detect obstructions in a single direction relative to the device. However, multiple non-Doppler non-Radar obstruction sensing devices may be mounted to cargo 210 to detect obstructions in multiple directions. For example, a non-Doppler non-Radar obstruction sensing device 204A oriented to the front of cargo 210 and/or vehicle 202 may be provided, and a second non-Doppler non-Radar obstruction sensing device 204B oriented to the rear of cargo 210 and/or vehicle 202 may be provided.

In some embodiments, the alarm signal 208 or different alarm signals may be provided for obstructions sensed in different directions. An alert provider may provide a alarm signal 208 when an obstruction is sensed. The signal may be directed to a remote 206 within the vehicle 202 or on the user. In some embodiments, the signal may be directed downward into a cabin of the vehicle 202 and may be displayed as alarm signal 208 on the display system 302. In other embodiments, the signal may be directed in a wide range of directions, or in all directions, to may be picked up by the remote 206.

The remote 206 may receive a alarm signal 208 from the non-Doppler non-Radar obstruction sensing device 204. The remote may be a device that alerts a user when it receives the alarm signal. The remote may alert the user by making an audio sound. For example, the remote may issue an audible alarm that may be of sufficient volume to capture the user's attention. The remote may have a pitch that captures the user's attention. The remote may issue a visual alert. For example, a light may start flashing. In some embodiments, the remote may start vibrating. Any combination of audio, movement, and/or visual alarms may be provided.

The remote 206 may alert the user when an obstruction is detected and a alarm signal 208 is provided. In some embodiments, the signal may just be a signal that an obstruction is detected. In some embodiments, the signal may indicate the distance that an obstruction is from the cargo 210, or may indicate a range of distances. In some embodiments, when the alarm signal provides some indication of distance, the alert provided by the alert to the user may change based on the distance. For example, the remote may provide a louder alert as the obstruction gets closer. The remote may add visual aspects to an audio alert as the obstruction gets closer. Such differences in alerts provided to the user may be continuous and may have a direct relationship to the distance. Alternatively, differences in the alerts provided to the user may be discrete and may depend on the distance range that the obstruction falls into (e.g., distance ranges may be provided with 10-foot increments and different alerts may be provided for each of these increments).

In some embodiments, the alarm signal 208 may indicate the direction of the obstruction relative to the vehicle 202. The remote 206 may correspondingly indicate the direction of the obstruction relative to the vehicle. If the vehicle is approaching an obstruction to the front, and different alarm or the same alarm may be issued as when the vehicle is backing into an obstruction.

The remote may take any shape of form. The remote may be a portable device. The remote may be incorporated into a keychain of a user. The remote may be provided as a box or device that a user may carry around. The remote can be worn by the user, e.g., on the wrist. This may be useful in applications where the remote may vibrate or move. The remote may be incorporated or integral to the vehicle. For example, when an alarm signal is received, the warning may come to the user via the radio or speaker of the user's vehicle. The remote may be provided external to the vehicle. Alternatively, the remote may be brought into or remain within a cabin of the vehicle.

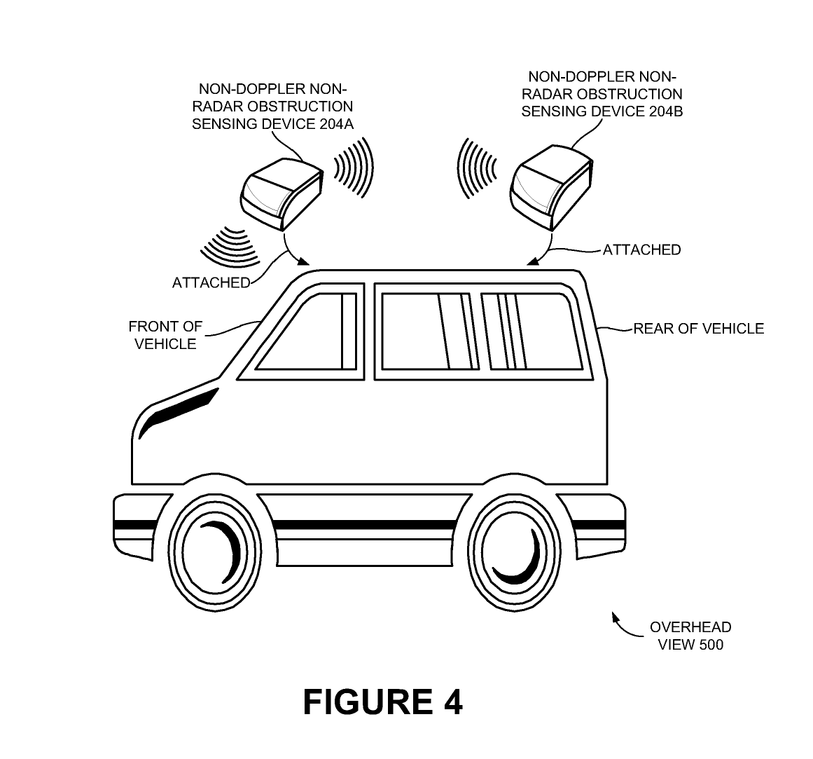

According to FIG. 4 and one or more embodiments, the non-Doppler non-Radar obstruction sensing device 204 may be located anywhere along the length of the cargo 210 or vehicle 202. For example, the non-Doppler non-Radar obstruction sensing device 204 may be provided towards the top of the cargo 210, or lower toward the bottom of the cargo 210. In some embodiments, the non-Doppler non-Radar obstruction sensing device 204 may be provided at the top of the cargo 210, or about 5%, 10%, 20%, 30%, 40%, 50%, 60%, 70%, 80%, or 90% of the way down cargo 210. A user may select where the non-Doppler non-Radar obstruction sensing device 204 is mounted to the cargo 210. Once mounted, the non-Doppler non-Radar obstruction sensing device 204 may have a fixed position relative to the cargo 210, and need not change position while the cargo 210 is being transported. In some embodiments, while mounted, a user may or may not be able to adjust the device position along the cargo 210. In some embodiments, the user may have to detach the device from the cargo 210 to adjust the position of the device.

The non-Doppler non-Radar obstruction sensing device 204 may be mounted to point in any direction relative to the cargo 210. For example, the front of the device, which may be the direction in which signals are emitted or received, may be oriented to correspond to the front of the cargo. Alternatively, the front of the device may be mounted to correspond to the back of the cargo, the side of the cargo, or any angle within 360 degrees relative to the front of the cargo.

The non-Doppler non-Radar obstruction sensing device 204 may provide a alarm signal 208. In some embodiments, the signal may be an RF signal. The non-Doppler non-Radar obstruction sensing device 204 may send the information via RF signal to a remote located on the user or within the user's vehicle. In addition, the non-Doppler non-Radar obstruction sensing device 204 may advantageously provide flexibility for options in mounting the device to detect an obstruction that may hit cargo 210 that is mounted on a vehicle. The non-Doppler non-Radar obstruction sensing device 204 may also allow a user to orient the device to detect an obstruction even when cargo 210 is mounted in different manners or when vehicles have different heights or configurations.

In some embodiments, the power source of the non-Doppler non-Radar obstruction sensing device 204 could become low on power. In some embodiments of the invention, when the power source is becoming low on power, the device may optionally warn a user. For example, if a battery is becoming low on charge, the device may send an alert to the remote. The alert provided by the remote to the user may optionally be less intrusive than an alarm for an approaching obstruction. The alert provided by the remote for low battery charge to the user may be different for an alarm for an approaching obstruction.

In some embodiments, the non-Doppler non-Radar obstruction sensing device 204 does not turn on unless the remote is within a particular distance from the device. This may prevent he power source from being unnecessarily drained. In some embodiments, while a remote is out of range, the device may remain off and the power source, such as a battery, may not be drained. When a remote comes into range, the non-Doppler non-Radar obstruction sensing device 204 may be turned on and one or more signal may be emitted from the obstruction sensing device to sense an obstruction. In some embodiments, the range may be about 3 feet or less, 4 feet or less, 5 feet or less, 6 feet or less, 7 feet or less, 8 feet or less, 9 feet or less, 10 feet or less, 11 feet or less, 12 feet or less, 13 feet or less, 14 feet or less, 15 feet or less, 20 feet or less, 25 feet or less, or 30 feet or less between the device and the remote. In some embodiments, the non-Doppler non-Radar obstruction sensing device 204 does not turn on unless the remote is within a cabin of the vehicle.

In some embodiments, the remote may emit a signal that may be received by the non-Doppler non-Radar obstruction sensing device 204. When the obstruction sensing device receives the signal from the remote, it may turn on and fully function. In some embodiments, the non-Doppler non-Radar obstruction sensing device 204 may passively receive the signal from the remote. In alternate embodiments, the non-Doppler non-Radar obstruction sensing device 204 may occasionally send out a signal querying whether a remote is within range. If the remote is within range, the device may enter a fully functional state. Similar technologies to automobiles that may unlock when a key is in close proximity may be utilized.

It will be appreciated that, according to one exemplary embodiment, the obstruction sensing device may comprise the non-Doppler non-Radar obstruction sensing device 204 mounted to a cargo 210 on a vehicle 202. An emitter 102 may be configured to emit a detection signal. At least one laser 105 may be configured to trigger an alarm signal 208 based on an obstruction; and a transmitter configured to transmit an alarm signal 208 from a display system 302 in the vehicle 202. In another embodiment, the engagement mechanism may be configured to attach the non-Doppler non-Radar obstruction sensing device 204 to the cargo 210 mounted on a vehicle 202.

The processor 103 may be in communication with the emitter 102 and transmitter and the non-Doppler non-Radar obstruction sensing device 204 may contain a power source 104 in communication with the processor 103, according to one or more embodiments. According to some embodiments, the detection signal may be an infrared signal and the alarm signal 208 may be an RF signal.

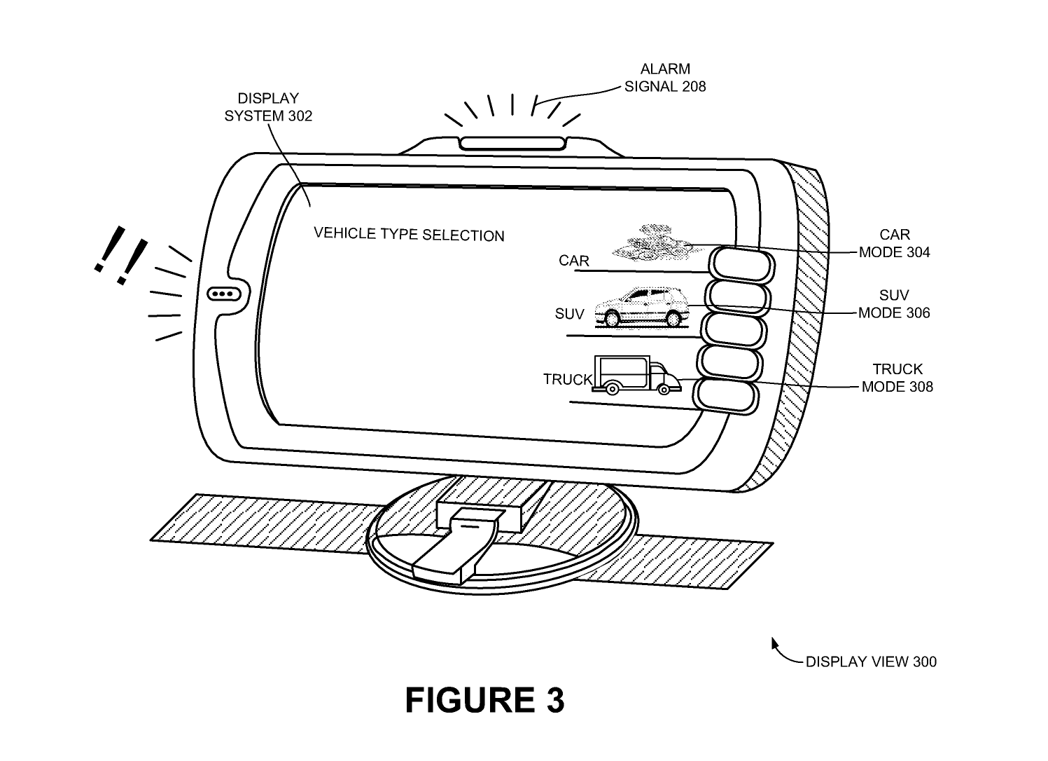

FIG. 3 is a display view 300, according to one or more embodiments. Upon detection of an obstruction, the non-Doppler non-Radar obstruction sensing device 204 may communicate with a display system 302 to display an alarm signal 208. The display system 302 may permit different modes of operation of vehicle 202. For example, the display system 302 may offer a car mode 304, a SUV mode 306, and/or a truck mode 308 depending on the type of vehicle.

According to one or more embodiments, the system may comprise the non-Doppler non-Radar obstruction sensing device 204 configured to attach to a cargo 210 mounted on a vehicle 202, wherein the non-Doppler non-Radar obstruction sensing device 204 has a transmitter configured to transmit an alarm signal (e.g., alarm signal 208) based on obstruction sensing by a laser 105. A remote 206 may be configured to receive the alarm signal 208 and provide a sensory alarm (e.g., alarm signal 208) to a user within the vehicle 202.

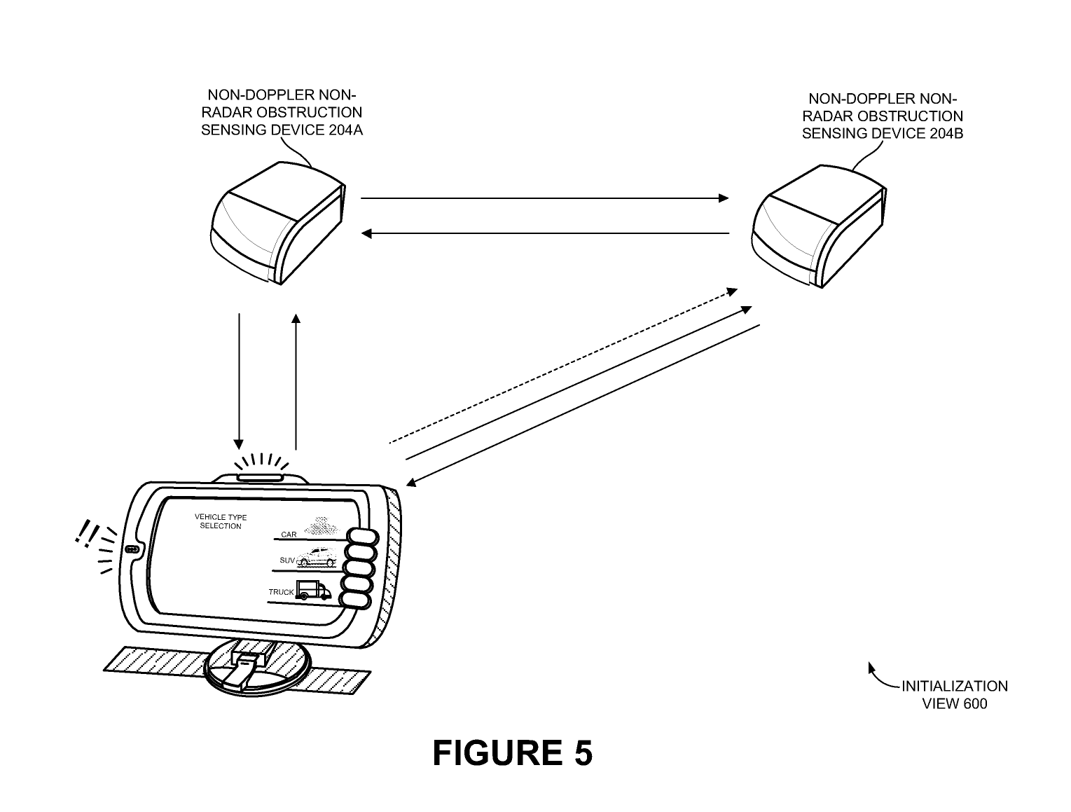

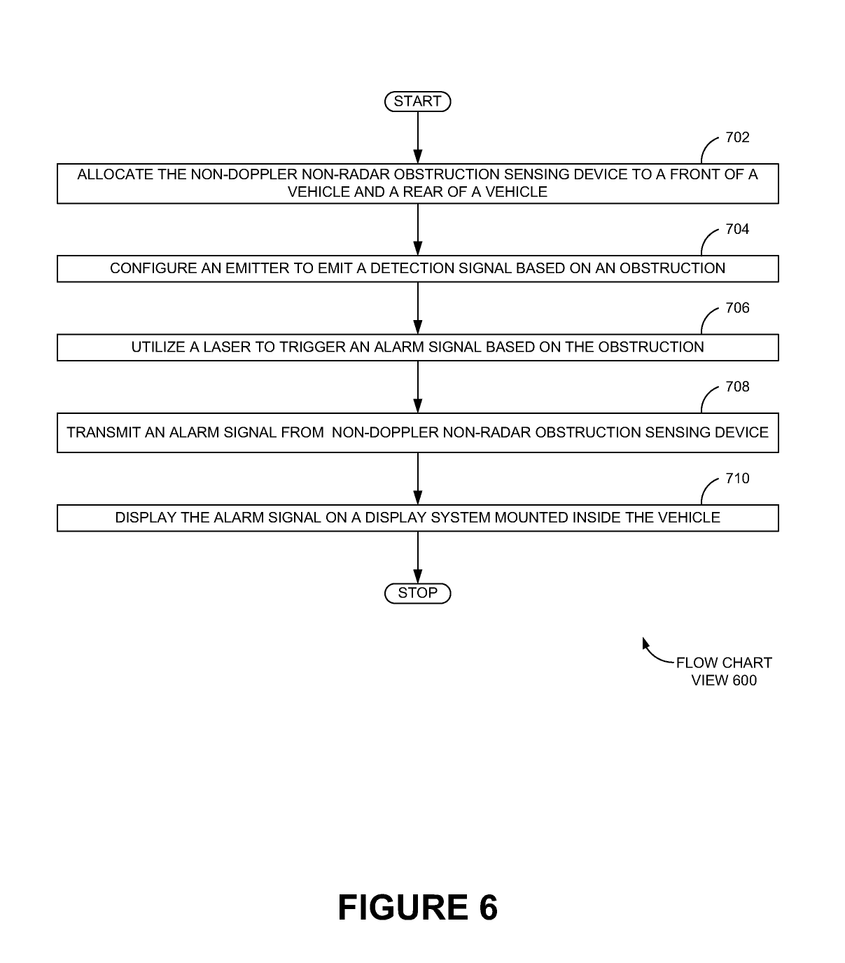

FIG. 5 is an initialization view 600 and FIG. 6 is a flow chart view 600, according to one or more embodiments. FIG. 5 shows the interaction between display system 302 and the non-Doppler non-Radar obstruction sensing devices 204A and 204B, according to one embodiment. FIG. 6 is a flow chart showing the allocation of the non-Doppler non-Radar obstruction sensing device 204 to the front of vehicle 202, rear of vehicle 202, or both. An emitter 102 may be configured to emit a detection signal based on an obstruction. A laser 105 may be utilized to trigger an alarm signal 208 on display system 302 (i.e., alarm signal 208 of FIG. 2 and FIG. 3).

According to another embodiment, a method to sense an overhead obstruction on a vehicle using the non-Doppler non-Radar obstruction sensing device 204 may comprise attaching the non-Doppler non-Radar obstruction sensing device 204 to the front of the vehicle 202 and/or a rear of the vehicle 202. The method may also comprise configuring an emitter 102 to emit a detection signal, configuring at least one laser 105 to trigger an alarm signal 208, transmitting an alarm signal 208 when the laser detects an obstruction and displaying the alarm signal 208 on a display system 302 mounted inside the vehicle 202, according to one or more exemplary embodiments.

The display system 302 may be configured to operate in at least one of a car mode 304, a sport utility vehicle mode 306 and a truck mode 308 (see FIG. 3). The two non-Doppler non-Radar obstruction sensing devices (204A and 204B) may be attached to the front of the vehicle 202 and at least two non-Doppler non-Radar obstruction sensing devices may be attached to the rear of the vehicle 202. Both the non-Doppler non-Radar obstruction sensing devices may be mounted to the front of the vehicle and the rear of the vehicle with at least one laser that may cross each other at one specific point in the front of the vehicle and in the rear of the vehicle. The laser may trigger the alarm signal on the display system notifying a user of the vehicle of an oncoming obstruction. The laser has at least one breaking point.

The laser sensor may have a jack on the back where one may plug in the laser sensor to define a single point in space where an object (i.e., cargo 210) may be photographed or captured. The laser beams may be arranged to cross each other, and a picture may be taken only when an object breaks both beams at their point of intersection. A toggle switch on the laser sensor may also allow the two lasers (e.g., laser 105) to be used independently, so a picture may be taken when an object breaks either beam (see FIG. 5). The laser sensor device may be non-Doppler since the signal 208 may not be sending back a signal (i.e., receiving a signal) and non-Radar because it uses a laser and laser sensors, not electromagnetic waves to detect objects (e.g., cargo 210).

According to one embodiment, the obstruction detection system may use two non-Doppler non-Radar obstruction sensing devices in front of the vehicle and two non-Doppler non-Radar obstruction sensing devices in the rear of the vehicle. The non-Doppler non-Radar obstruction sensing devices may be mounted with lasers that may cross each other at specific points in front and in the rear of the vehicle. The area of interest may be above the vehicle in both the rear and front. According to another exemplary embodiment, the obstruction detection system may use one non-Doppler non-Radar obstruction sensing device in front of the vehicle and one non-Doppler non-Radar obstruction sensing device in the rear of the vehicle. The non-Doppler non-Radar obstruction sensing devices may be mounted with lasers that may cross each other at specific points in front and in the rear of the vehicle. The area of interest may be above the vehicle in both the rear and front. According to an illustrative example, the laser 105 may have several failsafe points. The laser 105 may have several breaking points before the user of the vehicle 202 may be notified (e.g., in the even that a bird or other non-lethal obstructions fly into the laser sensor). This may provide for only steady and oncoming objects breaking the barrier sensors.

Particularly, several modules may be employed to execute the present embodiments. All modules of FIGS. 1-7 may be enabled using software and/or using transistors, logic gates, and electrical circuits (e.g., application specific integrated ASIC circuitry) such as a security circuit, a recognition circuit, a dynamic landmark circuit, an ignition event circuit, a store circuit, a transform circuit, an ICE circuit, and other circuits.

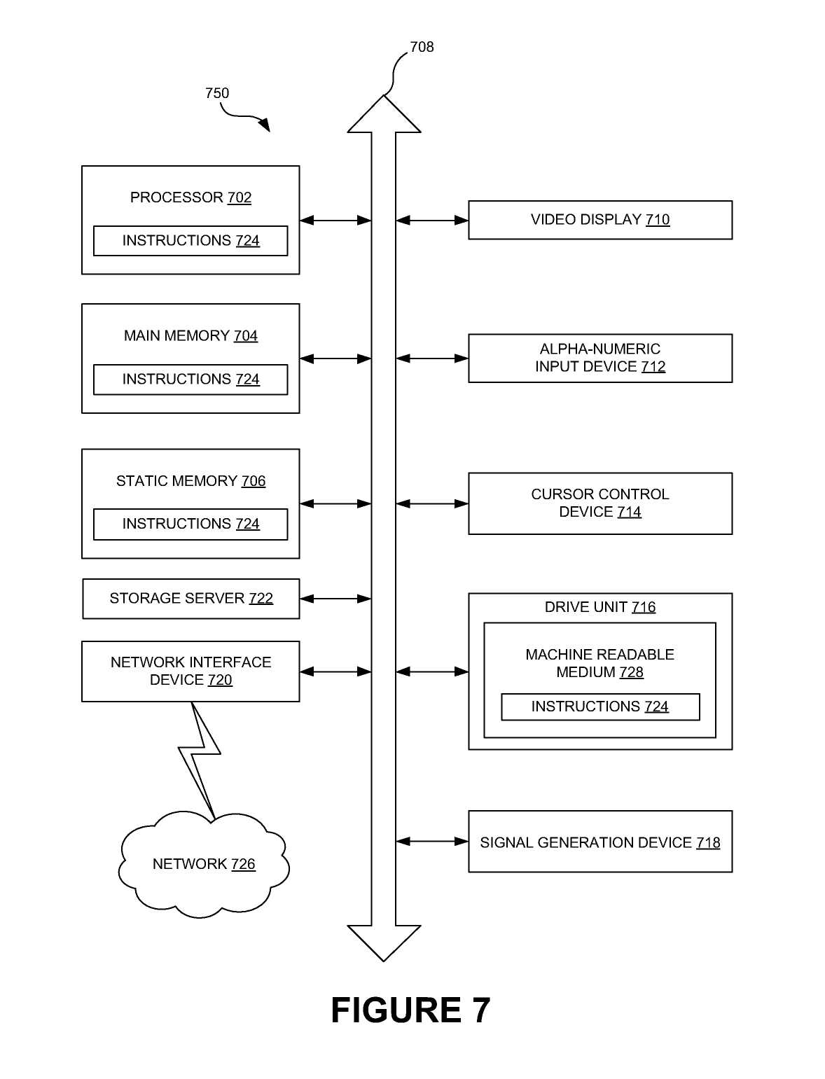

FIG. 7 may indicate a personal computer and/or the data processing system in which one or more operations disclosed herein may be performed. The processor 702 may be a microprocessor, a state machine, an application specific integrated circuit, a field programmable gate array, etc. (e.g., Intel® Pentium® processor, 620 MHz ARM1176®, etc.). The main memory 704 may be a dynamic random access memory and/or a primary memory of a computer system.

The static memory 706 may be a hard drive, a flash drive, and/or other memory information associated with the data processing system. The bus 708 may be an interconnection between various circuits and/or structures of the data processing system. The video display 710 may provide graphical representation of information on the data processing system. The alpha-numeric input device 712 may be a keypad, a keyboard, a virtual keypad of a touchscreen and/or any other input device of text (e.g., a special device to aid the physically handicapped). The cursor control device 714 may be a pointing device such as a mouse. The drive unit 716 may be the hard drive, a storage system, and/or other longer term storage subsystem. The signal generation device 718 may be a bios and/or a functional operating system of the data processing system. The network interface device 720 may be a device that performs interface functions such as code conversion, protocol conversion and/or buffering required for communication to and from the network 726. The machine readable medium 728 may provide instructions on which any of the methods disclosed herein may be performed. The instructions 724 may provide source code and/or data code to the processor 702 to enable any one or more operations disclosed herein.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. An obstruction sensing device comprising:
a non-Doppler non-Radar obstruction sensing device mounted to a cargo on a vehicle;
an emitter configured to emit a detection signal;
a laser configured to trigger an alarm signal based on an obstruction; and
a transmitter configured to transmit an alarm signal from a display system in the vehicle.

2. The device of claim 1 wherein an engagement mechanism is configured to attach the non-Doppler non-Radar obstruction sensing device to the cargo mounted on a vehicle.

3. The device of claim 1 further comprising a processor in communication with the emitter and transmitter.

4. The device of claim 4 further comprising a power source in communication with the processor.

5. The device of claim 1 wherein the detection signal is an infrared signal.

6. The device of claim 1 wherein the alarm signal is an RF signal.

7. An obstruction alerting system comprising:
a non-Doppler non-Radar obstruction sensing device configured to attach to a cargo mounted on a vehicle, wherein the non-Doppler non-Radar obstruction sensing device has a transmitter configured to transmit an alarm signal based on obstruction sensing by a laser; and
a remote configured to receive the alarm signal and provide a sensory alarm to a user within the vehicle.

8. A method to sense an overhead obstruction on a vehicle using a non-Doppler non-Radar obstruction sensing device comprising:
attaching the non-Doppler non-Radar obstruction sensing device to at least one of a front of the vehicle and a rear of the vehicle;
configuring an emitter to emit a detection signal;
configuring at least one laser to trigger an alarm signal;
transmitting an alarm signal when the laser detects an obstruction; and
displaying the alarm signal on a display system mounted inside the vehicle.

9. The method of claim 8 wherein the display system is configured to operate in at least one of a car mode, a sport utility vehicle mode, and a truck mode.

10. The method of claim 8 wherein at least two non-Doppler non-Radar obstruction sensing devices are attached to the front of the vehicle and at least two non-Doppler non-Radar obstruction sensing devices are attached to the rear of the vehicle.

11. The method of claim 10 wherein both the non-Doppler non-Radar obstruction sensing devices are mounted to the front of the vehicle and the rear of the vehicle with at least one laser that cross each other at at least one specific point in the front of the vehicle and in the rear of the vehicle.

12. The method of claim 11 wherein the laser triggers the alarm signal on the display system notifying a user of the vehicle of an oncoming obstruction.

13. The method of claim 12 wherein the laser has at least one breaking point.
